(19) United States
(12) Patent Application Publication
(10) Pub. No.: US 2008/0198184 A1
(43) Pub. Date: Aug. 21, 2008

(54) Fast and Interruptible Drive Scheme For Electrosphoretic Displays

(75) Inventors: Nicholaas W. Schellingerhout, Eindhoven (NL); Edzer A. Huitema, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,938

(22) PCT Filed: May 19, 2006
(86) PCT No.: PCT/IB06/51612

§ 371 Date: Nov. 9, 2007

Related U.S. Application Data
(60) Provisional application No. 60/683,649, filed on May 23, 2005.

(51) Int. Cl. G09G 5/10

(52) U.S. Cl. 345/692

(57) ABSTRACT

An image update scheme for an electrophoretic display reduces driving delays while allowing display of a reduced quality image when driving is interrupted. A first portion (605) of image data is transmitted to a display device (500) such as from a mobile network device (400). The first portion may include the MSB of a data word for each pixel. Each pixel (2) is driven to an associated first optical state (632) that is defined by the first portion. A second portion (606, 607) of the image data is subsequently received at the display device, and each pixel is driven to an associated second optical state (636) that is defined by the first and second portions. In another approach, the second portion includes a substantially complete representation of the image, and each pixel is driven to an associated second optical state (636) that is defined by the second portion.

The invention relates generally to an image update scheme for an electrophoretic display and, more particular, to an update scheme that reduces delays in driving the display while allowing a reduced quality image to be displayed when the driving is interrupted.

Recent technological advances have provided “user friendly” electronic reading devices such as e-books that open up many opportunities. For example, bi-stable displays such as electrophoretic displays hold much promise. Such displays have an intrinsic memory behavior and are able to hold an image for a relatively long time without power consumption. Power is consumed only when the display needs to be refreshed or updated with new information.

Furthermore, Philips Polymer Vision, Eindhoven, The Netherlands, is developing a rollable display. This display is stored rolled up in a stick when unused, and can be unrolled to provide the user with a large display. The rollable display device, which is especially suited for the mobile-device industry, includes an ultra-thin (100 μm), lightweight Quarter Video Graphics Array (QVGA) (320×240 pixels) active-matrix display with a diagonal measurement of five inches and four grey levels. Apart from the display, the stick also contains electronics to wirelessly connect to other devices, such as a mobile phone, to obtain information, e.g., text and graphics that are to be displayed, as well as information for providing user interaction functions, e.g. buttons, to control the application. The display effect used by Polymer Vision is electrophoresis. Electrophoretic displays include the E-ink display provided by E Ink Corporation, Cambridge, Mass., U.S.

However, the display update performance of such devices has been limited by different factors. For instance, electrophoretic displays generally are characterized by a slow update speed, e.g., of about 0.5 seconds. Additionally, low-power wireless links, such as Bluetooth, are also relatively slow, taking into account the amount of data to be transmitted. Bluetooth is a short-range radio frequency (RF) technology that operates at 2.4 GHz at an effective data rate of typically 600-700 Kbit/s and is capable of transmitting voice and data over an effective range of about ten meters. For instance, considering that a 16 greylevel QVGA image has 4*320*240=307,200 bits, the transmission time will be about 0.5 sec., which is comparable to the display update time. Moreover, in traditional driving schemes, the data must be transmitted completely before rendering can begin. As a consequence, the total update time is the sum of the data transmit time and the display update time, which can become unacceptably long. Also, it is not possible to quickly interrupt the update process and leave the display in an approximately correct state until the data transfer has completed fully and driving has started.

The present invention addresses the above and other issues by providing an update scheme that substantially reduces the update time of an electrophoretic display while allowing a reduced quality image to be displayed when the driving is interrupted. Driving can be interrupted before the image has been rendered to full quality, which is advantageous, e.g., for scrolling. The invention is especially suited for use with portable devices with electrophoretic displays such as rollable displays, as well as other bi-stable display devices.

In a particular aspect of the invention, a method for displaying an image on a bi-stable display device based on image data received thereat includes: receiving a first portion of the image data at the display device, driving each of a number of pixels of the display device to an associated first optical state that is defined by the first portion, receiving a second portion of the image data at the display device, and driving each of the pixels to an associated second optical state that is defined by the first and second portions.

In a related aspect, a method for transmitting image data to a bi-stable display device includes: transmitting a first portion of the image data to the display device, where the first portion defines an associated first optical state to which each of a number of pixels of the display device is to be driven, and transmitting a second portion of the image data to the display device, where the first and second portions define an associated second optical state to which each of the pixels is to be driven.

In another aspect, a method for displaying an image on a bi-stable display device based on image data received thereat, includes: receiving a first portion of the image data at the display device, driving each of a number of pixels of the display device to an associated first optical state that is defined by the first portion, receiving a second portion of the image data at the display device, and driving each of the pixels to an associated second optical state that is defined by the second portion.

In a related aspect, a method for transmitting image data to a bi-stable display device, includes transmitting a first portion of the image data to the display device, where the first portion defines an associated first optical state to which each of a number of pixels of the display device is to be driven, and transmitting a second portion of the image data to the display device, where the second portion defines an associated second optical state to which each of the pixels is to be driven.

Corresponding electrophoretic display devices and program storage devices are also provided.

In the drawings:

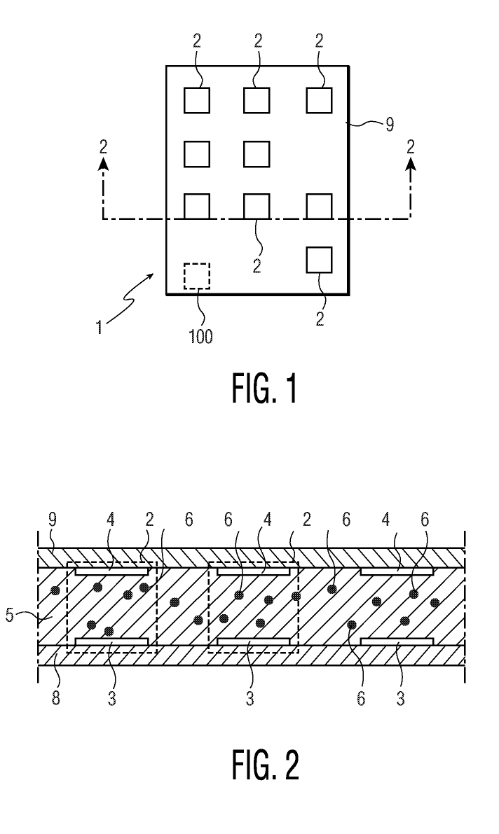

FIG. 1 illustrates a front view of an embodiment of a portion of a display screen of a bi-stable display device;

FIG. 2 illustrates a cross-sectional view along 2-2 in FIG. 1;

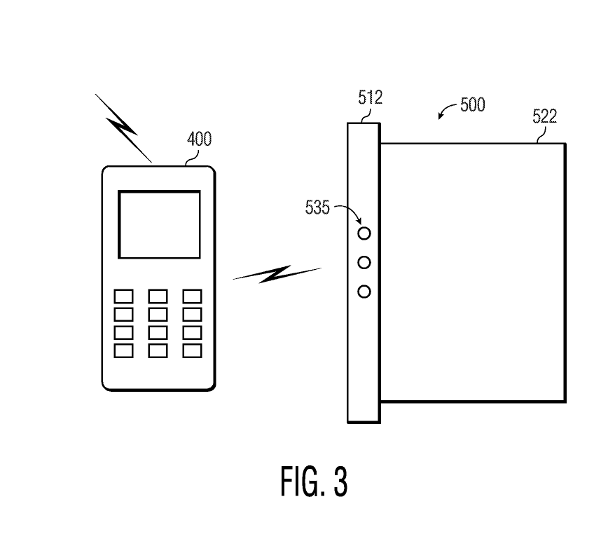

FIG. 3 illustrates a network device transmitting image data to a rollable bi-stable display device, in accordance with the invention;

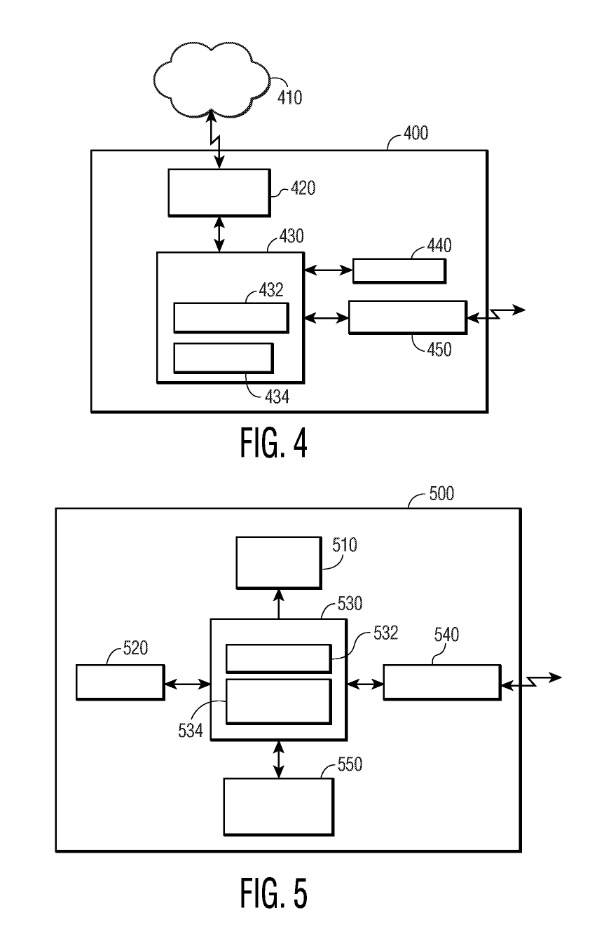

FIG. 4 illustrates a network device, in accordance with the invention;

FIG. 5 illustrates a display device, in accordance with the invention; and

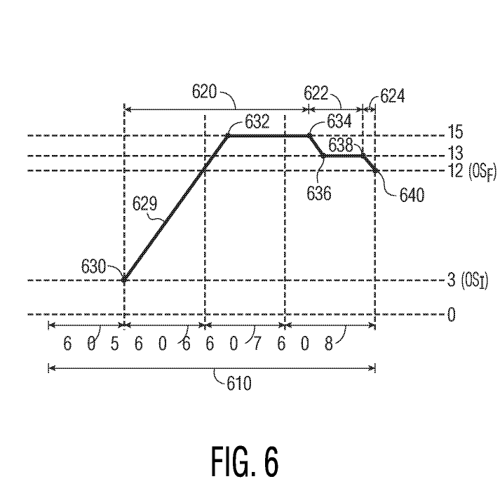

FIG. 6 illustrates optical states of a display relative to update time, in accordance with the invention.

In all the Figures, corresponding parts are referenced by the same reference numerals.

FIGS. 1 and 2 illustrate a portion of a display panel 1 of a bi-stable display device having a first substrate 8, a second opposed substrate 9 and a plurality of picture elements or pixels 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element 2 has an appearance determined by the position of the charged particles 6 between the electrodes 3 and 4. Electrophoretic media 5 are known per se, e.g., from U.S. Pat. Nos. 5,961,804, 6,120,839, and 6,130,774.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. A drive control controls the potential difference of each picture element 2 to create a desired picture, e.g., images and/or text, in a full display screen. The full display screen is made up of numerous picture elements that correspond to pixels in a display.

FIG. 3 illustrates a network device transmitting image data to a rollable bi-stable display device, in accordance with the invention. As mentioned at the outset, the bi-stable display device may be provided, in one possible implementation, on a rollable display. In the example of FIG. 3, a network device 400 is a mobile phone that communicates with a rollable display device 500, which includes a tube 512 and a rollable screen 522 which can be housed in the tube in a rolled up state when not in use, and pulled out from the tube by the user when in use. The network device 400 can communicate with the display device 500 via a low power, wireless link, e.g., using the Bluetooth standard, in one possible approach. With this approach, the network device 400 can receive image data of any type, e.g., including images of text, from a network such as a mobile phone network or the Internet, and communicate the data to the display device 500 for display thereon. The image data can provide any type of content, including e-mail, e-books, news, sports and so forth. In accordance with the invention, the network device 400 provides the image data in a format that enables the display device 500 to quickly render the image while also allowing the rendering to be interrupted, such as when the user operates the user interface buttons 535, e.g., to perform scrolling. The display device may also have a local storage resource for storing image data to render.

FIG. 4 illustrates a network device 400, such as the mobile phone discussed in connection with FIG. 3, in accordance with the invention. The network device 400 may communicate, via a network interface 420, with a network 410 such as a mobile phone network or the Internet to receive image data for use by the display device 500. A control 430 includes an associated compression function 432 and a filtering function 434 for processing the image data before transmitting it to the display device 500 via a transceiver 450. An associated working memory 440 may be provided for use by the control 430 as well.

The image data can include a number of multi-bit words, where each word defines an optical state to which a corresponding pixel in the display device is to be driven. In one possible communication scheme, a first portion of the image data is first communicated to the display device 500. The display device responds to the receipt of the first portion by driving each pixel accordingly. A second portion of the image data can then be transmitted to the display device. The display device responds to the receipt of the second portion by further driving each pixel based on information gained from the first and second portions. The process may continue with subsequent transmissions to the display device such that the display device can continue to refine its driving commands in distinct phases or stages until the final image is displayed.

In another possible approach, the filtering function 434 is used to provide a dithered black-and-white image approximating the original greyscale image, for instance, which is improved in later stages. This can be advantageous for images where showing the correct greyscales is more important than resolution. In yet another possible approach, the compression function 432 is used to compress the image data prior to its transmission to the display device 500. The compression function 432 can use compression algorithms to improve the update speed of the display device even further. Dithering and compression are discussed further below.

FIG. 5 illustrates a display device such as the display device 500 of FIG. 3, in accordance with the invention. The display device 500 can include a control 530, which includes a decompression function 532 and an addressing circuit 534. The control 530 controls the display screen 510 to cause a desired image to be displayed. For example, the control 530 may drive the display screen 510 by providing voltage waveforms to the different pixels in the display screen 510. The addressing circuit 534 provides information for addressing specific pixels, such as row and column, to cause the desired image to be displayed. The image data may be received from the network device 400 via a transceiver 540, and stored in a memory 520, one example of which is the Philips Electronics small form factor optical (SFFO) disk system. The control 530 may further be responsive to user commands provided via a user interface 550, e.g., for scrolling up, down, left or right, paging up and down, and so forth. The transceivers 450 and 540 may communicate with one another via a low power, wireless link. The display device may transmit a confirmation message upstream to the network device 400 indicating that the image data has been received.

The controls 430 and 530 may include processors that can execute any type of computer code devices, such as software, firmware, micro code or the like, to achieve the functionality described herein. Accordingly, a computer program product or program storage device that tangibly embodies such computer code devices, such as the memories 440 and 520, may be provided in a manner apparent to those skilled in the art.

FIG. 6 illustrates optical states of a display relative to update time, in accordance with the invention. As mentioned at the outset the present invention addresses the fact that electrophoretic display have a slow update time, low-power wireless links are also slow, and, in traditional driving schemes, the image data must be transmitted completely before rendering can begin. The total update time thus, conventionally, is based on the sum of the data transmit time and the display update time.

The invention addresses these problems by providing a drive scheme that can start driving the electrophoretic display while only part of the image information is known, in a meaningful and visually attractive way, by gradually increasing the quality of the image, e.g., adding grey or color levels. This results in a higher update speed while also enabling the driving to be interrupted before the image has been rendered to full quality.

In FIG. 6, time intervals 605, 606, 607 and 608 represent the transmission of image data, which is split into four phases, each representing one respective bit for every pixel in the image. Time interval 610 represents the total transmission time. Note that the transmission of a bit does not necessarily consume the entire time period 605, 606, 607 or 608. Time intervals 620, 622 and 624 represents first, second and third pixel driving phases, respectively. Points 630, 632, 634, 636, 638 and 640 represent points along a path or trajectory 629 that describes the optical state to which the example pixel is driven when the associated image data has the binary value 1100. The right hand side of the figure indicates greyscale levels between 0 and 15. OS_{I} indicates an initial optical state and OS_{F} indicates a final optical state. Note that the invention can be applied as well to color displays by controlling the driving of the subpixel color components.

As an example, a four-bit word with bits 1100 is transmitted from the network device to the display device. In the first transmission phase 605, the most-significant bit (MSB) for every pixel is transmitted. As soon as this phase has been completed, the pixel is driven, in the initial driving phase 620, from the initial optical state (OS_{I}), represented by point 630, as follows. If the MSB is “1”, driving starts towards the highest grey level, in this case, level “15”. The driven pixel reaches this level at the point 632. If the MSB is 0, driving starts towards the lowest grey level, e.g., level “0”. These bounding levels may be considered to be rail states. Note that this decision is taken for every pixel separately. Every pixel is thus driven to a well-defined state, after which each pixel can be driven to the correct, final grey level accurately and quickly. At the end of the first driving phase 620, also referred to as the MSB driving phase, a black-and-white image approximating the new image is visible on the display 510. Thus, the optical state represented by point 632 is defined based on information from the first portion of the image data, e.g., the MSB.

During the MSB driving phase 620, additional data can be transmitted. In the present example, two more bits for every pixel can be transmitted in the time periods 606 and 607, e.g., one bit in the time period 606, and one bit in the time period 607. This data is subsequently used to improve the quality of the image in the refinement phase 622 by driving the pixel from the optical state represented by point 634 to the optical state represented by point 636. In this case, there was time to send three out of four bits for every pixel, so that an eight (2³)-grey level image can be generated. Thus, the optical state represented by point 636 is defined based on information from the first portion of the image data, e.g., the MSB, and from the second portion of the image data, e.g., the second and third lesser significant bits.

Once the pixel is at the optical state represented by point 636, driving stops for a while until the final bit has been transmitted in the time period 608. Once this information has been received, driving to the final level starts, from the optical state represented by point 638 to the optical state represented by point 640, at which point the 16-greylevel image is correctly displayed in its final optical state. Thus, the optical state represented by point 640 is defined based on information from the first portion of the image data, e.g., the MSB, the second portion of the image data, e.g., the second and third lesser significant bits, and the third, remaining portion of the image data, e.g., the least significant bit (LSB).

Note that there is sufficient time for the pixel to reach the state at point 632 based on the received MSB. Thus, when the pixel is subsequently driven, e.g., to point 636, it is driven from the state defined by the MSB. However, the transmission of the second and third bits could be fast enough so that the pixel is driven, at least partly, to the second optical state at point 636 before the pixel has achieved the first optical state at point 632 or 634. Nevertheless, allowing time for the pixel to fully reach the first optical state is a reliable way to obtain a good image quality since the bi-stable nature of the display makes it very hard to accurately control the final grey level for a pixel that is not initially driven to a well-defined, reference state. Instead, accurate control can be achieved by driving the pixel to a well-defined first state, such as one of the two extreme, black or white states, and from that state, refining the driving of the pixel towards the final grey level. Moreover, the invention could work in theory with driving to one or more intermediate states if they could be attained reliably.

Table 1 shows how a pixel can be driven to the correct final state via intermediate levels for every possible 4-bit grey level. For the example image data value of 1100, the driving sequence is first to level 15 (MSB driving), then to level 15 (after two bits have been received), then to level 13 (after 3 bits have been received), and finally to level 12 (after all four bits have been received). The table can be modified accordingly as fewer or more bits are used to define each optical state.

TABLE 1

| 4 bit code | MSB (1 bit) | 2 bits | 3 bits | Final (4 bits) |
|---|---|---|---|---|
| 0000 | 0 | 0 | 0 | 0 |
| 0001 | 0 | 0 | 0 | 1 |
| 0010 | 0 | 0 | 2 | 2 |
| 0011 | 0 | 0 | 2 | 3 |
| 0100 | 0 | 4 | 4 | 4 |
| 0101 | 0 | 4 | 4 | 5 |
| 0110 | 0 | 4 | 6 | 6 |
| 0111 | 0 | 4 | 6 | 7 |
| 1000 | 15 | 11 | 9 | 8 |
| 1001 | 15 | 11 | 9 | 9 |
| 1010 | 15 | 11 | 11 | 10 |
| 1011 | 15 | 11 | 11 | 11 |
| 1100 | 15 | 15 | 13 | 12 |
| 1101 | 15 | 15 | 13 | 13 |
| 1110 | 15 | 15 | 15 | 14 |
| 1111 | 15 | 15 | 15 | 15 |

As an alternative to transmitting only the MSB initially, it is possible to transmit more than one bit for defining the initial, reference state to which a pixel is driven. While in current driving schemes this does not usually help because all the information needed for this initial driving phase is contained in the MSB, in general, it is helpful to have as much information as early as possible, so there may be situations where this is useful. However, sending two or more MSBs takes longer than sending only one MSB and therefore the complete image update time, which is the sum of transmission time and driving time, will be longer, unless the extra information in the extra bit(s) can be exploited to reduce the driving time by a sufficient amount. For example, if the display can be driven reliably to four different grey levels directly, then it might be beneficial to send two or more MSBs in the first phase. Also, in this case, driving to the two most extreme levels can start after the first bit has been received. Then, as soon as the second bit is received, the driving can be changed, if necessary, towards one of the four levels, and only then is the refinement phase started. This requires some additional control of the driving but is feasible. For example, assume it is possible to drive directly to grey levels 0, 5, 10, and 15, instead of just to 0 and 15. Also, assume that driving to these four reference states is as fast as driving to 0 and 15 in the above-mentioned scheme. Then, the total driving time will be shorter than in the above-mentioned scheme, since the worst case (e.g., grey level 7) now can be reached from state 5, which will be faster than reaching it from 0 (this second phase will be approximately (7−0)/(7−5)=3.5 times as fast).

In a further alternative, the image data transmitted to the display device may be compressed by the network device using the compression function 432 mentioned previously. Or, the image data may be received by the network device already in the compressed form. The compression can be achieved in various ways. For example, the stream of all MSBs can be compressed using standard binary compression algorithms, such as run-length encoding. Other techniques from image/video compression, such as quad trees, can also be used. For the compression of the least or less significant bits (LSBs), many techniques may be applied as well. Again, ordinary binary compression techniques can be used. Also, image/video compression techniques can be applied, although the missing MSBs can introduce high-frequency components that reduce the degree of compression. In another approach, standard image compression techniques may be used on the full image so that, after the MSB stream is sent to provide a compressed representation of a portion of the image, a compressed representation of substantially the full image, e.g., an entirety of the image, can be sent to the display device in lieu of the data stream with the lesser significant bits and the LSB. The display device can use the decompression function 532 to reverse the effects of the compression function 432.

In another option, the filtering function 434 may be used to provide a dithered image. Or, the image data may be received by the network device already in the filtered form. This option can result in visually less annoying image transitions. In this approach, a black-and-white image is sent in the first transmission phase, but that image is not just the one-bit version of the original images obtained by dropping all the LSBs; rather, it is a version that has been filtered (or dithered) to give the illusion of grey levels. Once all of the grey levels have been removed and replaced by pure black-and-white dithering patterns, only the MSB remains, in one possible approach. The second portion, which is sent in the second transmission phase, can then contain the complete image data

Note that, in this option, the strategy is still, as it is in the other options described, to send the most important information first, to speed up total image update time, but the distinction between the most and least important information is not made on a strict pixel-by-pixel basis. An important application for this case is that of displaying photographs, where grey-level information may be more important than image resolution.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for displaying an image on a bi-stable display device based on image data received thereat, the method comprising:
receiving a first portion (605) of the image data at the display device (500);
driving each of a plurality of pixels (2) of the display device to an associated first optical state (632) that is defined by the first portion;
receiving a second portion (606, 607) of the image data at the display device; and
driving each of the plurality of pixels to an associated second optical state (636) that is defined by the first and second portions.

2. The method of claim 1, wherein:
for each of the plurality of pixels, the first portion comprises a most significant bit of a multi-bit word of the image data.

3. The method of claim 2, wherein:
for each of the plurality of pixels, the associated first optical state is the highest or lowest optical state in an optical scale based on a value of the associated most significant bit.

4. The method of claim 2, wherein:
for each of the plurality of pixels, the second portion comprises at least one less significant bit of the multi-bit word of the image data.

5. The method of claim 1, further comprising:
receiving at least one remaining portion (608) of the image data at the display device; and
driving each of the plurality of pixels to an associated final optical state (640) that is defined by the associated first, second and remaining portions.

6. The method of claim 1, wherein:
each of the plurality of pixels is driven to the associated second optical state from the associated first optical state.

7. The method of claim 1, wherein:
the first and second portions are received at the display device via a low power, wireless link.

8. The method of claim 1, wherein:
the first and second optical states comprise at least one of greyscale levels and color levels.

9. The method of claim 1, wherein:
the first portion comprises a dithered representation (434) of an image.

10. A bi-stable display device, comprising:
means (540) for receiving a first portion (605) of the image data at the display device (500);
means (530, 534) for driving each of a plurality of pixels (2) of the display device to an associated first optical state (632) that is defined by the first portion;
means (540) for receiving a second portion (606, 607) of the image data at the display device; and
means for driving each of the plurality of pixels to an associated second optical state (636) that is defined by the first and second portions.

11. A method for transmitting image data to a bi-stable display device, comprising:
transmitting a first portion (605) of the image data to the display device (500);
wherein the first portion defines an associated first optical state (632) to which each of a plurality of pixels (2) of the display device is to be driven; and
transmitting a second portion (606, 607) of the image data to the display device;
wherein the first and second portions define an associated second optical state (636) to which each of the plurality of pixels is to be driven.

12. The method of claim 11, wherein:
for each of the plurality of pixels, the first portion comprises a most significant bit of a multi-bit word of the image data.

13. The method of claim 12, wherein:
for each of the plurality of pixels, the first optical state is the highest or lowest optical state in an optical scale based on a value of the associated most significant bit.

14. The method of claim 12, wherein:
for each of the plurality of pixels, the second portion comprises at least one less significant bit of the multi-bit word of the image data.

15. The method of claim 11, further comprising:
transmitting at least one remaining portion (608) of the image data to the display device;
wherein the first, second and at least one remaining portion define an associated final optical state (640) to which each of the plurality of pixels is to be driven.

16. The method of claim 11, wherein:
the first and second portions are transmitted to the display device via a low power, wireless link.

17. An apparatus for transmitting image data to a bi-stable display device, comprising:
means (450) for transmitting a first portion (605) of the image data to the display device (500);
wherein the first portion defines an associated first optical state (632) to which each of a plurality of pixels (2) of the display device is to be driven; and
means (450) for transmitting a second portion (606, 607) of the image data to the display device;
wherein the first and second portions define an associated second optical state (636) to which each of the plurality of pixels is to be driven.

18. A method for displaying an image on a bi-stable display device based on image data received thereat, the method comprising:
receiving a first portion (605) of the image data at the display device (500);
driving each of a plurality of pixels (2) of the display device to an associated first optical state (632) that is defined by the first portion;
receiving a second portion (606, 607) of the image data at the display device; and
driving each of the plurality of pixels to an associated second optical state (636) that is defined by the second portion.

19. The method of claim 18, wherein:
the first portion comprises a dithered representation (434) of an image; and
the second portion comprises a substantially complete representation of the image.

20. The method of claim 18, wherein:
the first portion comprises a partial representation of an image; and
the second portion comprises a substantially complete representation of the image.

21. A method for transmitting image data to a bi-stable display device, comprising:
transmitting a first portion (605) of the image data to the display device (500);
wherein the first portion defines an associated first optical state (632) to which each of a plurality of pixels (2) of the display device is to be driven; and
transmitting a second portion (606, 607) of the image data to the display device;
wherein the second portion defines an associated second optical state (636) to which each of the plurality of pixels is to be driven.

22. The method of claim 21, wherein:
the first portion comprises a dithered representation (434) of an image; and
the second portion comprises a substantially complete representation of the image.

23. The method of claim 21, wherein:
the first portion comprises a partial representation of an image; and
the second portion comprises a substantially complete representation of the image.
